(19) United States
(12) Patent Application Publication
(10) Pub. No.: US 2021/0397339 A1
(43) Pub. Date: Dec. 23, 2021

(54) INTERFACES PRESENTATIONS ON DISPLAYS

(71) Applicant: Hewlett-Packard Development Company, L.P., Spring, TX (US)

(72) Inventors: Ron Yiran Zhang, Fort Collins, CO (US); Lu-Yen Lai, Taipei (TW); Wei-Yu Lin, Taipei (TW); Dhruv Jain, Mississauga (CA); Cheng-Tsung Wu, Taipei (TW); Yannick Quentin Pivot, Spring, TX (US)

(73) Assignee: Hewlett-Packard Development Company, L.P., Spring, TX (US)

(21) Appl. No.: 17/054,187

(22) PCT Filed: Mar. 13, 2019
(86) PCT No.: PCT/US2019/022001

§ 371 Date: Nov. 10, 2020

(51) Int. Cl. G06F 3/0488; G06F 3/0484; G06F 3/14

(52) U.S. Cl. CPC G06F 3/04886; G06F 2203/04803; G06F 3/1423; G06F 3/04847

(57) ABSTRACT

An example non-transitory computer-readable storage medium comprises instructions that, when executed by a processing resource of a computing device, cause the processing resource to present an interface of an application on a first display of the computing device. The instructions further cause the processing resource to, in response to receiving a selection of a boundary that defines a portion of the interface, present the portion on a second display of the computing device.

### BACKGROUND

Many computing devices and other electronic devices, such as mobile phones, desktop and laptop computers, tablets, digital cameras, and other similar devices execute applications and present content, such as user interfaces for the applications, on displays. An example computing device having multiple displays can present different content (e.g., different interfaces) on the multiple displays. In some examples, a computing device having multiple displays presents the same content (e.g., the same interface) on the multiple displays.

### BRIEF DESCRIPTION OF THE DRAWINGS

The following detailed description references the drawings, in which:

FIG. 1 depicts a computing device having a first display to present an interface and a second display to present a portion of the interface according to examples described herein;

FIG. 2 depicts a computing device to present an interface on a first display and present a portion of the interface on a second display according to examples described herein;

FIG. 3 depicts a computer-readable storage medium comprising instructions to present an interface on a first display and present a portion of the interface on a second display according to examples described herein;

FIG. 4 depicts a flow diagram of a method that presents an interface on a first display and presents a portion of the interface on a second display according to examples described herein;

FIG. 5 depicts the first display and the second display of FIG. 1, the second display to present portions of the interface according to examples described herein;

FIGS. 6A and 6B depict the first display and the second display of FIG. 1, the second display to present portions of the interface according to examples described herein; and

FIG. 7 depicts a flow diagram of a method that presents an interface on a first display and presents a portion of the interface on a second display according to examples described herein.

### DETAILED DESCRIPTION

Multiple displays continue to be a desirable feature to users of computing devices and other electronic devices capable of executing applications. For example, a user of a computing device may desire to view an interface of an application on multiple displays (e.g., a first display and a second display). In some examples, it may be desirable for the user to view an interface on a first display and to view a portion of the interface on a second display.

Various implementations are described below by referring to several examples of interface presentation on multiple displays that present an interface of an application on a first display of a computing device and present a portion of the interface on a second display of the computing device. The portion is defined by a boundary selected automatically (e.g., based on the content of the interface) and/or manually (e.g., by a user selecting the boundary using an input device of the computing device).

In some examples, the boundary defining the portion of the interface of the application is saved, such as to a database, for future use. In such examples, when the application is subsequently launched, the portion is automatically presented on the second display based on the saved boundary. In examples, the second display is a touch-enabled display to receive touch inputs. These touch inputs on the second display manipulate the application executing on the computing device. For example, a user can interact with the portion of the interface by providing a touch input on the second display. In examples, the portion of the interface is modified when the portion is presented on the second display. For example, the portion can be enlarged, reduced, stretched, etc., when the portion is displayed on the second display.

In one example implementation, a non-transitory computer-readable storage medium is provided. The computer-readable storage medium stores instructions that, when executed by a processing resource of a computing device, cause the processing resource to present an interface of an application on a first display of the computing device. The instructions further cause the processing resource to, in response to receiving a selection of a boundary that defines a portion of the interface, present the portion on a second display of the computing device. Other example implementations of interface presentation on displays are described below.

The present techniques provide a multi-display experience by presenting a portion of an interface on a second display based on a selected boundary defining the portion. This enables automatic and/or manual selection of a boundary and presentation of the bounded portion of the interface on the second display. Additional examples of the present techniques provide the boundary to be saved for future use. In such examples, when an application is later launched, the portion can be presented on the second display automatically without the boundary being selected again.

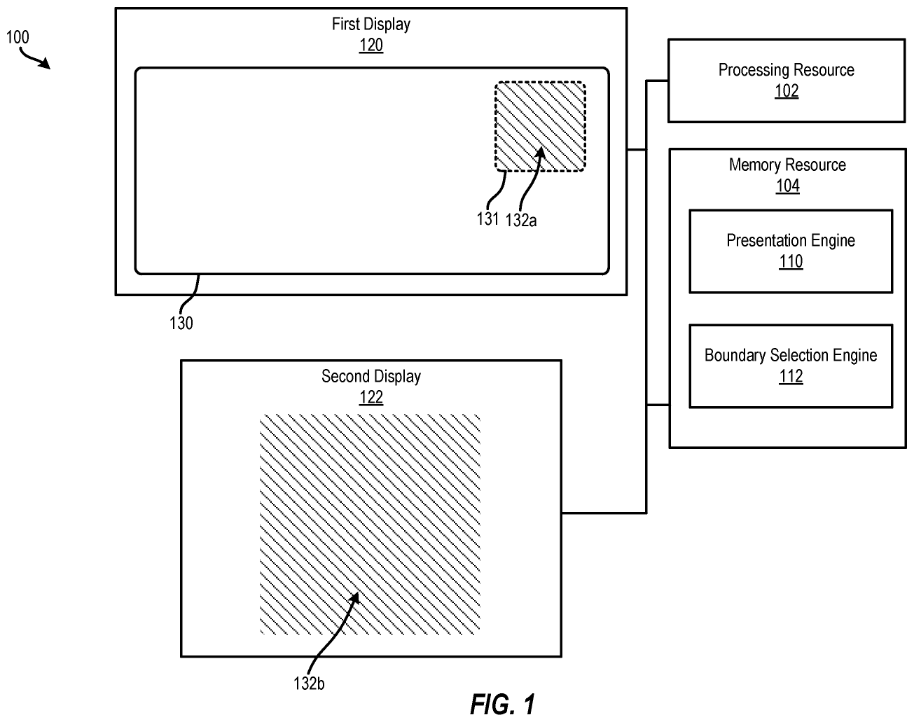

FIGS. 1-3 include components, modules, engines, etc. according to various examples as described herein. In different examples, more, fewer, and/or other components, modules, engines, arrangements of components/modules/engines, etc. can be used according to the teachings described herein. In addition, the components, modules, engines, etc. described herein can be implemented as software modules executing machine-readable instructions, hardware modules, special-purpose hardware (e.g., application specific hardware, application specific integrated circuits (ASICs), field programmable gate arrays (FPGAs), embedded controllers, hardwired circuitry, etc.), or some combination of these.

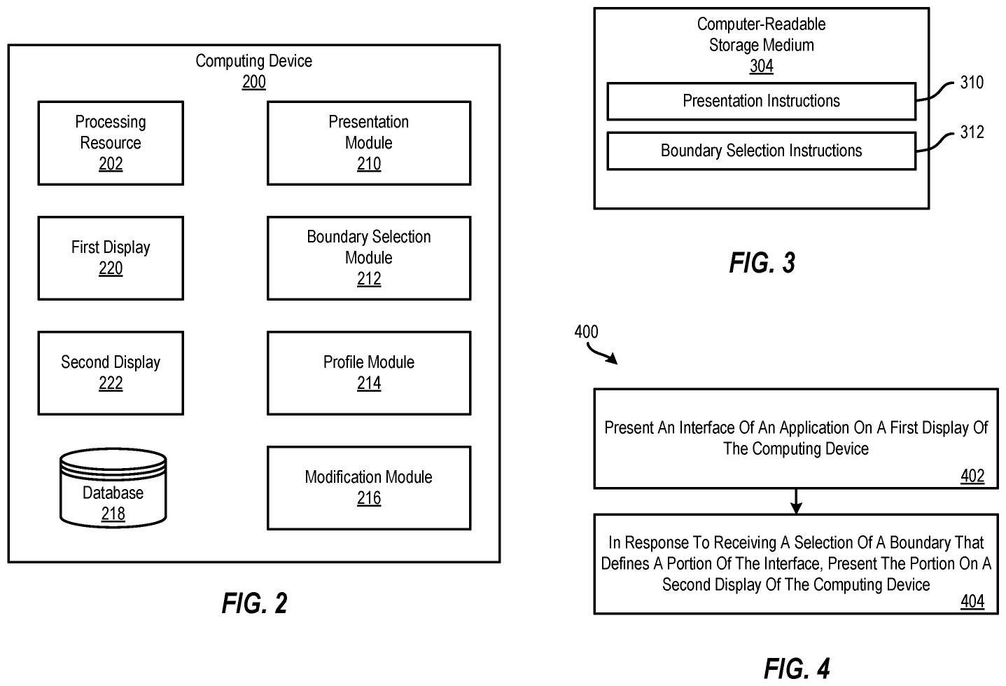

FIGS. 1-3 relate to components and modules of a computing device, such as a computing device 100 of FIG. 1 and a computing device 200 of FIG. 2. In examples, the computing devices 100 and 200 are any appropriate type of computing device, such as smartphones, tablets, desktops, laptops, workstations, servers, smart monitors, smart televisions, digital signage, scientific instruments, retail point of sale devices, video walls, imaging devices, peripherals, networking equipment, wearable computing devices, or the like.

FIG. 1 depicts a computing device 100 having a first display 120 to present an interface 130 and a second display 122 to present a portion 132b of the interface 130 according to examples described herein.

The computing device 100 includes a processing resource 102 that represents any suitable type or form of processing unit or units capable of processing data or interpreting and executing instructions. For example, the processing resource 102 includes central processing units (CPUs), microprocessors, and/or other hardware devices suitable for retrieval and execution of instructions. The instructions are stored, for example, on a non-transitory tangible computer-readable storage medium, such as memory resource 104 (as well as memory resource 204 of FIG. 2 and/or computer-readable storage medium 304 of FIG. 3), which may include any electronic, magnetic, optical, or other physical storage device that store executable instructions. Thus, the memory resource 104 may be, for example, random access memory (RAM), electrically-erasable programmable read-only memory (EPPROM), a storage drive, an optical disk, and any other suitable type of volatile or non-volatile memory that stores instructions to cause a programmable processor to perform the techniques described herein. In examples, memory resource 104 includes a main memory, such as a RAM in which the instructions are stored during runtime, and a secondary memory, such as a nonvolatile memory in which a copy of the instructions is stored.

Alternatively or additionally in other examples, the computing device 100 includes dedicated hardware, such as integrated circuits, ASICs, Application Specific Special Processors (ASSPs), FPGAs, or any combination of the foregoing examples of dedicated hardware, for performing the techniques described herein. In some implementations, multiple processing resources (or processing resources utilizing multiple processing cores) may be used, as appropriate, along with multiple memory resources and/or types of memory resources.

The first display 120 and the second display 122 represent generally any combination of hardware and programming that exhibit, display, or present a message, image, view, interface, portion of an interface, or other presentation for perception by a user of the computing device 100. In examples, the first display 120 and/or the second display 122 may be or include a monitor, a projection device, a touchscreen, and/or a touch/sensory display device. For example, the first display 120 and/or the second display 122 may be any suitable type of input-receiving device to receive a touch input from a user. For example, the first display 120 and/or the second display 122 may be a trackpad, touchscreen, or another device to recognize the presence of points-of-contact with a surface of the first display 120 and/or a surface of the second display 122. The points-of-contact may include touches from a stylus, electronic pen, user finger or other user body part, or another suitable source. The first display 120 and/or the second display 122 may receive multi-touch gestures, such as “pinch-to-zoom,” multi-touch scrolling, multi-touch taps, multi-touch rotation, and other suitable gestures, including user-defined gestures.

The first display 120 and/or the second display 122 can display text, images, and other appropriate graphical content, such as an interface of an application and/or a portion of an interface of an application. In the example shown in FIG. 1, a presentation engine 110 causes the first display 120 to present an interface 130 and the second display 122 to present a portion 132b of the interface 130. For example, when an application executes on the computing device 100, the presentation engine 110 presents the interface 130 on the first display 120. The boundary selection engine 112 enables selection of a boundary 131 that defines a portion 132a of the interface 130. For example, using an input device (not shown), a user can define the portion 132a by drawing, outlining, marking, tracing, selecting, or otherwise designating the boundary 131. As an example, a user can use a mouse cursor to select the boundary 131 to define the portion 132a.

In examples, a trigger event occurs to enable selection of the portion 132a. A trigger event can be caused automatically and/or manually. For example, a new application launches, which represents the trigger event; a user is then prompted to define the portion 132a by selecting the boundary 131. As another example of a trigger event, a user initiates selecting the boundary 131 manually by selecting an option on the interface 130, by selecting an option on another interface, by pressing a keyboard shortcut or a dedicated button, by using a voice command, and the like. The user then defines the portion 132a by selecting the boundary 131.

Once the boundary 131 is selected to define the portion 132a of the interface, the presentation engine 110 causes the second display 122 to present the portion 132a as portion 132b. The second display 122 acts to “clone” the portion 132a of the interface 130 by presenting the portion 132b on the second display 122. In examples, the first display 120 continues to present the interface 130, including the portion 132a.

As shown in the example of FIG. 1, the portion 132b can be enlarged when presented on the second display 122. Other modifications in addition to enlargement are also possible. For example, the portion 132b can be reduced, stretched in a horizontal direction, stretched in a vertical direction, cropped, and the like, including combinations thereof.

FIG. 2 depicts computing device 200 to present an interface on a first display and present a portion of the interface on a second display according to examples described herein. Similarly to the computing device 100 of FIG. 1, the example computing device 200 of FIG. 2 includes a processing resource 202, a first display 220, a second display 222, and a database 218.

Additionally, the computing device 200 includes a presentation module 210, a boundary selection module 212, a profile module 214, and a modification module 216. These modules may be stored, for example, in a computer-readable storage medium or a memory, or the modules may be implemented using dedicated hardware for performing the techniques described herein.

The presentation module 210 presents the interface 130 for an application on the first display 120. The application can be any suitable type of application, such as a game application, a communication application, a productivity application, a social media application, a media player application, and others.

The boundary selection module 212 selects a boundary to define the portion 132a of the interface 130. In an example, the boundary selection module 212 prompts a user to manually select a boundary to define the portion 132a of the interface 130. In another example, the boundary selection module 212 receives a boundary selection from the database 218 of stored boundary selections. For example, when a boundary is selected, the profile module 214 enables the boundary selection to be stored to the database 218 for subsequent use. When the application launches again, the saved boundary selection can be used to present the portion 132b of the interface 130 on the second display 122.

The modification module 216 modifies the portion 132b by modifying a property of the portion of the interface. The property can be of a dimension (e.g., height or width of the portion), a size of the portion (e.g., a scale/zoom of the portion 132b compared to the portion 132a), a color, a shape, a rotation, a crop, and the like. For example, the modification module 216 enlarges the portion 132b to fill the second display 122, reduces the portion 132b to fit on the second display 122, crops the portion 132b to fit on the second display 122, rotates the portion 132b, and/or otherwise modifies the portion 132b. Other modifications are also possible, such as orientation (rotation), zoom, shape (e.g., stretch in a horizontal and/or a vertical direction), and the like.

FIG. 3 depicts a computer-readable storage medium 304 comprising instructions to present an interface (e.g., the interface 130) on a first display (e.g., the first display 120) and present a portion (e.g., the portion 132a) of the interface on a second display (e.g., the second display 122) according to examples described herein. The computer-readable storage medium 304 is non-transitory in the sense that it does not encompass a transitory signal but instead is made up of memory components that store the instructions. The computer-readable storage medium may be representative of the memory resource 104 of FIG. 1 and may store machine-executable instructions in the form of modules or engines, which are executable on a computing device such as the computing device 100 of FIG. 1 and/or the computing device 200 of FIG. 2.

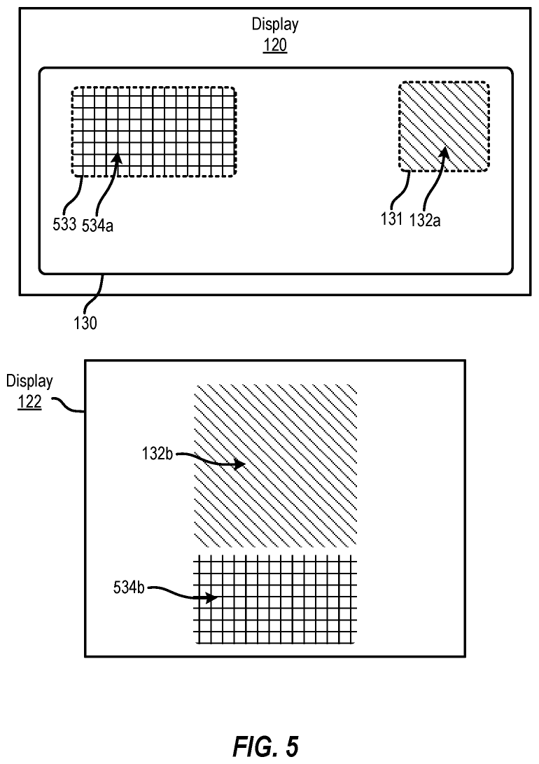

In the example shown in FIG. 3, the instructions include presentation instructions 310 and boundary selection instructions 312. The instructions of the computer-readable storage medium 304 are executable to perform the techniques described herein, including the functionality described regarding the method 400 of FIG. 4. The functionality of these modules is described below with reference to the functional blocks of FIG. 4 but should not be construed as so limiting.

In particular, FIG. 4 depicts a flow diagram of a method 400 that presents an interface (e.g., the interface 130) on a first display (e.g., the first display 120) and presents a portion (e.g., the portion 132a) of the interface on a second display (e.g., the second display 122) according to examples described herein. The method 400 is executable by a computing device such as the computing device 100 of FIG. 1 and/or the computing device 200 of FIG. 2.

The presentation instructions 310 present the interface 130 of an application on the first display 120 of the computing device 100 (block 402). In examples, the boundary selection instructions 312 enable the selection of the boundary 131 that defines the portion 132a of the interface 130. As described herein, a user can select, such as by drawing, outlining, marking, tracing, selecting, or otherwise designating the boundary 131 using an input device (not shown) associated with the computing device 100.

In response to receiving the selection of the boundary 131 that defines the portion 132a of the interface, the presentation instructions 310 present the portion 132b on the second display 122 of the computing device 100 (block 404).

According to an example, the first display 120 has a first size and a first aspect ratio and the second display 122 has a second size and a second aspect ratio. For example, the first display 120 is an approximate 15″ (diagonal) display and the second display 122 is an approximate 6″ (diagonal) display. In other examples, other sizes of displays can be used. The presentation instructions 310 can present the portion 132b on the second display 122 based on the size of the second display 122. For example, the presentation instructions 310 can present the portion 132b on the second display 122 to fill the second display.

Additional processes also may be included, and it should be understood that the processes depicted in FIG. 4 represent illustrations and that other processes may be added or existing processes may be removed, modified, or rearranged without departing from the scope and spirit of the present disclosure.

For example, the method 400 can include modifying (e.g., enlarging, reducing, etc.) the portion 132b presented on the second display 122. In such examples, the computer-readable storage medium 304 includes modification instructions to modify the portion 132b.

In another example, the method 400 can include saving the boundary 131 defining the portion 132a for future use. For example, when the application is subsequently launched, the presentation instructions 310 can present the portion 132b on the second display 122 based on the previously selected boundary 131 that defines the portion 132a. Boundaries can be saved per user, per application, per computing device, and the like, to enable boundaries to be saved and reused in different cases. For example, when an application is launched, the boundary 131 can be selected to define the portion 132a to be displayed on the second display 122. The boundary 131 is saved for future use. When the application is subsequently launched, the portion 132b is automatically displayed on the second display 122 without the boundary 131 having to be selected again.

According to an example, multiple boundaries can be selected to define multiple portions of the interface. For example, FIG. 5 depicts the first display 120 to present the interface 130 and the second display 122 to present portions 132b, 534b of the interface 130 according to examples described herein.

In the example of FIG. 5, with reference to FIG. 1, the boundary selection engine 112 is used to select two boundaries 131, 533 to define two respective portions 132a, 534a. The portions 132a, 534a can vary in size, layout, orientation, position, etc. In some examples, parts of the portions 132a, 534a can overlap.

The presentation instructions 310 present the portions 132b, 534b on the second display 122. The size, layout, orientation, position, etc., of the portions 132b, 534b on the second display 122 can be determined manually by a user and/or automatically by the presentation instructions 310. For example, a size of each of the portions 132b, 534b is modified (e.g., reduced and/or enlarged) to present both of the portions 132b, 534b on the second display 122 at the same time (i.e., concurrently). As shown in FIG. 5, the size of the portion 132b is enlarged compared to the portion 132a while the size of the portion 534b remains approximately the same compared to the portion 534a.

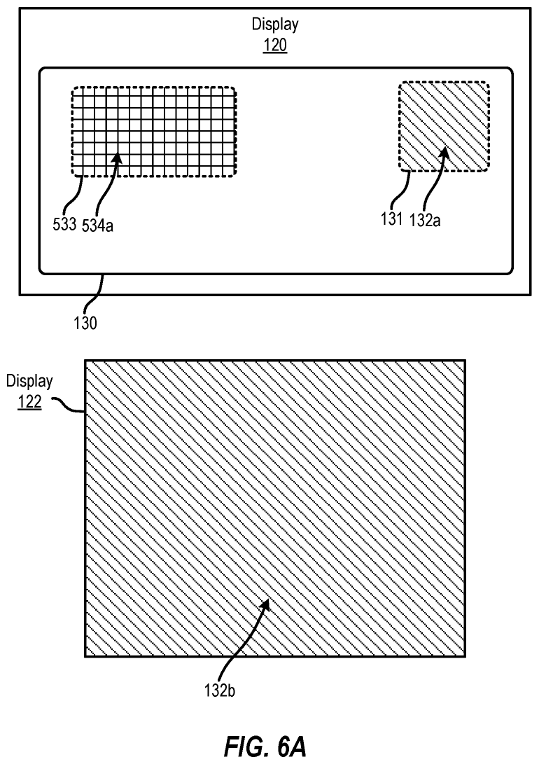

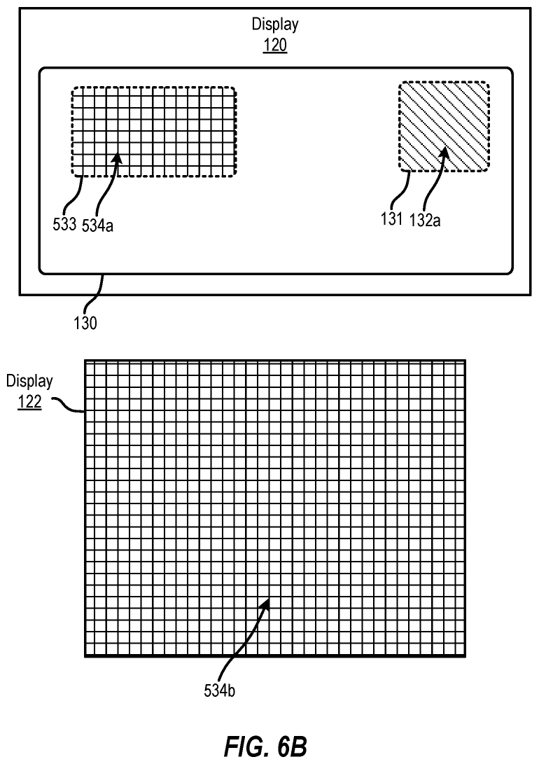

Other examples of selecting multiple boundaries to define multiple portions of the interface are also possible. As one such example, consider FIGS. 6A and 6B, which depict the first display 120 to present the interface 130 and the second display 122 to present portions 132b, 534b of the interface 130 according to examples described herein. In this example, the portions 132b, 534b are modified (i.e., enlarged) to fill the entirety of the second display 122 and are presented in alternating fashion. For example, the portion 132b is presented on the second display 122 for a first duration (e.g., 0.1 second, 0.5 seconds, 1 second, 2 seconds, 3 seconds, 5 seconds, 8 seconds, etc.). Subsequent to the expiration of the first duration, the portion 534b is presented on the second display 122 for a second duration. Subsequent to the expiration of the second duration, the second display 122 presents the portion 132b again (see FIG. 6B) or presents another portion (not shown) for example. In other examples, the second display 122 presents the portions 132b, 534b of the interface 130 based on a manual selection. For example, responsive to a user command (e.g., pressing a button or keyboard shortcut), the second display 122 switches from presenting the portion 132b to the portion 534b. Responsive to receiving a second user command, the second display 122 switches back to presenting the portion 132b (or another portion).

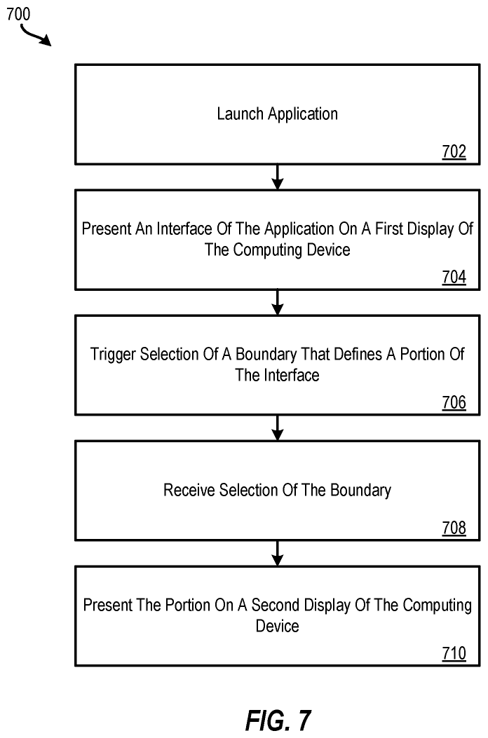

FIG. 7 depicts a flow diagram of a method 700 that presents an interface (e.g., the interface 130) on a first display (e.g., the first display 120) and presents a portion (e.g., the portion 132a) of the interface on a second display (e.g., the second display 122) according to examples described herein. The method 400 is executable by a computing device such as the computing device 100 of FIG. 1 and/or the computing device 200 of FIG. 2.

The computing device 100 launches an application (block 702), and the presentation module 210 presents the interface 130 of an application on the first display 120 of the computing device 100 (block 704). A trigger event occurs to trigger selection of a boundary 131 that defines a portion 132a of the interface 130 (block 706). A trigger event can be the launch of the application, a user initiating selecting the boundary 131 (such as using a keyboard shortcut command, selecting an option on the interface 130 (or another interface) to select the boundary 131, etc.), or another suitable action. The boundary selection module 212 then receives the selection of the boundary 131 (block 708). The boundary selection can be received, for example, from a user manually selecting the boundary, from the application automatically selecting the boundary, and/or from the database 218 of previously selected boundaries via the profile module 214. For example, a user selects the boundary 131 and saves the boundary. The profile module 214 causes the database 218 to store the boundary selection for future use. When the application is subsequently launched, the profile module 214 can retrieve the boundary selection from the database 218. The presentation module 210 then presents the portion 132b of the interface 130 on the second display 122 of the computing device 100 (block 710).

In the example in which the application is a game, a user selects a boundary around a mini-map, item inventory, score indicator, etc., as the portion 132b of the interface 130 for display on the second display 122. In examples, the boundary selection module 212 automatically identifies a portion or portions of the interface 130 for display on the second display 122 based on a type of the application and content of the interface of the application. For example, a type of application being a game application, the boundary selection module 212 automatically identifies a mini-map as the content of the interface and generates a boundary around the mini-map to define the mini-map as the portion 132b for presentation on the second display 122. As another example, in the case of a productivity application type (e.g., a spreadsheet application), the boundary selection module 212 identifies a cell or cells of interest (e.g., a cell containing a total of another group of cells, a cell containing an average value of another group of cells, a frequently modified cell, etc.,) and generates a boundary around the cell or cells of interest for presentation on the second display 122.

Additional processes also may be included, and it should be understood that the processes depicted in FIG. 7 represent illustrations, and that other processes may be added or existing processes may be removed, modified, or rearranged without departing from the scope and spirit of the present disclosure.

It should be emphasized that the above-described examples are merely possible examples of implementations and set forth for a clear understanding of the present disclosure. Many variations and modifications may be made to the above-described examples without departing substantially from the spirit and principles of the present disclosure. Further, the scope of the present disclosure is intended to cover any and all appropriate combinations and sub-combinations of all elements, features, and aspects discussed above. All such appropriate modifications and variations are intended to be included within the scope of the present disclosure, and all possible claims to individual aspects or combinations of elements or steps are intended to be supported by the present disclosure.

What is claimed is:

1. A non-transitory computer-readable storage medium comprising instructions that, when executed by a processing resource of a computing device, cause the processing resource to:
present an interface of an application on a first display of the computing device; and
in response to receiving a selection of a boundary that defines a portion of the interface, present the portion on a second display of the computing device.

2. The non-transitory computer-readable storage medium of claim 1, wherein the first display has a first size, and wherein the second display has a second size, the first size differing from the second size.

3. The non-transitory computer-readable storage medium of claim 2, wherein the portion is modified to be presented on the second display to fill the second display based on the second size.

4. The non-transitory computer-readable storage medium of claim 1, wherein the instructions further cause the processing resource to enlarge the portion presented on the second display.

5. The non-transitory computer-readable storage medium of claim 1, wherein the instructions further cause the processing resource to reduce the portion presented on the second display.

6. The non-transitory computer-readable storage medium of claim 1, wherein the instructions further cause the processing resource to save the boundary defining the portion for subsequent use.

7. A non-transitory computer-readable storage medium comprising instructions that, when executed by a processing resource of a computing device, cause the processing resource to:
present an interface of an application on a first display of the computing device; and
in response to receiving a first selection of a first boundary that defines a first portion of the interface and in response to receiving a second selection of a second boundary that defines a second portion of the interface, present the first portion, the second portion, or a combination thereof on a second display of the computing device, wherein the first selection, the second selection, or a combination thereof is received from a database, wherein the first portion is presented for a first duration and, subsequent to expiration of the first duration, the second portion is presented for a second duration.

8. The non-transitory computer-readable storage medium of claim 7, wherein, subsequent to expiration of the second duration, the first portion is presented for the first duration again.

9. A computing device comprising:
a first display;
a second display;
a processing resource to:
present an interface of an application on the first display;
identify, automatically based on a type of the application, a boundary that defines a portion of the interface to be presented on the second display; and
present the portion of the interface on the second display.

10. The computing device of claim 9, the processing resource further to:
modify a property of the portion of the interface presented on the second display to enlarge or reduce the portion to fill the second display.

11. The computing device of claim 10, wherein the property is selected from the group consisting of a size, a shape, and an orientation.

12. The computing device of claim 9, the processing resource further to:
save the boundary that defines the portion of the interface to a database.

13. The computing device of claim 9, the portion being a first portion of the interface, the processing resource further to:
present a second portion of the interface on the second display concurrently with the first portion of the interface presented on the second display.

14. The computing device of claim 13, the processing resource further to:
enlarge or reduce the first portion, the second portion, or a combination thereof to enable the first portion and the second portion to be presented concurrently on the second display.

15. The computer device of claim 9, wherein the boundary is further identified automatically based on a content of the interface of the application.
